(19) United States
(12) Patent Application Publication
(10) Pub. No.: US 2013/0061885 A1
(43) Pub. Date: Mar. 14, 2013

(54) Method for removing overspray of thermal spray coatings

(71) Applicants: Wolfgang Treutmann, Ostfildem (DE); Gerhard Flores, Ostfildem (DE); Clemens Maria Verpoort, Monheim am Rhein (DE)

(72) Inventors: Wolfgang Treutmann, Ostfildem (DE); Gerhard Flores, Ostfildem (DE); Clemens Maria Verpoort, Monheim am Rhein (DE)

(73) Assignees: FORD-WERKE GMBH, KOELN (DE); GEHRING TECHNOLOGIES GMBH, OSTFILDERN (DE)

(21) Appl. No.: 13/577,445

(22) PCT Filed: Feb. 3, 2011
(86) PCT No.: PCT/EP2011/000483

§ 371 Date: Oct. 11, 2012

(30) Foreign Application Priority Data
Feb. 9, 2010 (DE) 2010 007 224.9

(51) Int. Cl. B08B 3/02; B05B 1/00

(52) U.S. Cl. 134/34; 239/589

(57) ABSTRACT

A method for removing the overspray of a coating which has been sprayed onto a workpiece directs at least one liquid jet from a jet lance as a hydrodynamic wedge in the parting plane between the workpiece and the overspray onto those regions of the workpiece which have overspray.

The properties of functional surfaces, such as for example the piston bearing surfaces in the cylinders of internal combustion engines, can be set and improved by coating, in particular by thermal coating. In thermal coating, the spray material fed as a wire or powder is melted in the process, such that individual particles (droplets) in the liquid or pasty state in the spray jet are moved against the substrate. The different particle size results in a core jet with completely melted particles and marginal jets on both sides with only partially melted particles, which run at a specific opening angle in relation to the core jet. The actual coating is effected with the core jet.

At the borders of the functional surface to be coated, e.g. at the upper and lower bore edges of a cylinder bore, the marginal jets leave the functional surface and settle on the workpiece outside the functional surface, where they form undesirable deposits. These deposits are referred to hereinbelow as overspray. The overspray is undesirable since it can detach from the workpiece during operation of the engine. The particles which are thereby formed in an uncontrolled manner pass into the oil circuit and cause increased wear, or even the total failure of the internal combustion engine.

To avoid overspray, the workpieces are often masked so that the adjacent surface cannot be coated. The masks required for this purpose have to be fastened by hand to the intended sites of the workpiece. Therefore, masking is very complicated and to date it has not been possible to automate this process. The thermal spraying of cylinder bores has therefore only been able to gain acceptance in small-scale production.

It is also possible to remove the overspray by chip-forming methods with a geometrically determined or undetermined cutting edge. It is difficult to automate this method on account of the geometries which are present in the crankcase underneath the cylinder bore.

Alternatively, it is also known to remove coatings from a substrate by high-pressure water blasting (see Lugscheider, E.: Handbuch der thermischen Spritztechnik. Fachbuchreihe Schweiβtechnik Volume 139, Verlag für Schweiβen and verwandte Verfahren DVS—Verlag GmbH, Düsseldorf. 2002. ISBN 3-87155-186-4, pages 116 ff.). In this case, a water jet is directed at high pressure more or less perpendicularly or diffusely onto the coating to be removed. The kinetic energy of the water jet destroys the adhering coating and consequently removes the coating. The water jet can be positioned with a high degree of precision and allows for targeted local removal in the desired regions. The disadvantage of the known hydromechanical removal methods consists in the high operating pressures of the water jet systems, which the literature states as being 150 MPa to 400 MPa. The surface of the workpiece can thus be inadmissibly altered or even damaged in the region of the marginal zone covered with overspray. In order to prevent the functional coating from being damaged by the high-pressure water jet, in some cases it is necessary for the functional coating to be protected from the high-pressure water jet by masks, which entails the disadvantages mentioned above. In addition, the high-pressure water blasting causes a high energy requirement for operation of the plant and requires very expensive plant engineering.

The object on which the invention is based consists in providing a method which makes it possible to remove overspray reliably in process terms on the surfaces adjacent to the bore, and in the process overcomes the disadvantages known from the prior art to the greatest possible extent. In particular, the intention is for the method to be suitable for large-scale production, which requires complete automation combined with low energy costs and high process reliability.

According to the invention, this object is achieved by a method for removing the overspray of a coating which has been sprayed onto a workpiece, in which method at least one liquid jet from a jet lance is directed onto those regions of the workpiece which are provided with overspray, wherein the at least one liquid jet is at an angle of smaller than 90°, preferably smaller than 60° and particularly preferably smaller than 30°, and greater than 5°.

The method according to the invention takes advantage of the knowledge that those surfaces of the workpiece which adjoin the actual functional surface have not been prepared especially for the application of a coating, such that the droplets or the particles bond less intensively to the workpiece than is the case on the actual functional surface. One reason for this is that, in the region of the functional surfaces, the coating is effected, as already mentioned, by the core jet with completely melted droplets. A further effect which impairs the bonding conditions between overspray and the surface of the substrate is that the droplets have to travel a further distance until they impinge on the region of the workpiece which is adjacent to the functional surface. The droplets thereby undergo greater cooling, which further reduces the adhesion thereof to the workpiece surface. The method according to the invention takes advantage of this knowledge by directing the liquid jet onto the surface of the workpiece at the flattest possible angle, which should be as small as possible, so as to achieve a good peeling action.

In practice, angles of smaller than 30°, preferably smaller than 20° and particularly preferably smaller than 10° have proved to be suitable. Ideally, the liquid jet acts more or less parallel to the contact surface between the substrate and the coating.

The peeling action according to the invention is promoted if the liquid jet is guided virtually from the outside, i.e. from the non-coated workpiece surface, in the direction of those regions of the workpiece surface which are affected by overspray. The removal of the overspray is thereby assisted by “peeling” instead of “shattering”.

The liquid jet thereby acts as a hydrodynamic wedge, which slides in the parting plane between the substrate or the surface of the workpiece and the coating which has been sprayed on (overspray). As a result, the removal of the overspray is simplified considerably. In addition, the orientation according to the invention of the liquid jet means that the operating pressure of the liquid jet can be reduced considerably, which has a positive effect on the energy requirement and therefore also on the operating costs.

In a further advantageous configuration of the method according to the invention, it is provided that the jet lance and/or the discharge direction of the at least one liquid jet from the jet lance is controlled depending on the orientation of the surface of the workpiece in the regions provided with overspray. It is thereby possible, even in the case of concavely or convexly curved surfaces of the substrate, to always achieve an optimum angle between the liquid jet and the surface at the point where the liquid jet impinges on the surface. Consequently, optimum removal conditions are always achieved, irrespective of the geometry in the surface contour of the workpiece, and therefore the method according to the invention can be used effectively and efficiently even given complicated geometries.

In a further advantageous configuration of the method according to the invention, it is provided that the jet lance performs a rotational movement. As a result, all regions around the jet lance are uniformly covered by the spray jet in the simplest possible manner and therefore the overspray is completely removed.

In order to make it possible to effectively remove the overspray as far as possible from all surface contours, to be precise also complex surface contours, of workpieces, it is provided that the direction of at least one liquid jet from the jet lance includes a first angle α with a plane, the so-called Z-R plane, defined by the axis of rotation of the jet lance and a radius line, and that the first angle α is greater than 5° and smaller than 85°.

In a further configuration of the method according to the invention, it is provided that the direction of at least one liquid jet includes a second angle β with a plane (X-Y plane) arranged perpendicularly in relation to a Z axis of the jet lance, and that the second angle is greater than 5° and smaller than 85°. As a result of these angle ranges, which are defined to some extent in a cylinder coordinate system connected permanently to the jet lance, the optimum removal conditions according to the invention for the overspray can be achieved even when the surfaces of workpieces provided with overspray have complicated contours.

In order for the method according to the invention to also be effective unchanged in the case of complex geometries, it is provided according to the invention that at least one nozzle of the jet lance can be pivoted, to be precise in such a way that the first angle α and the second angle β can be set in each case in ranges of between 5° and 85°. It is thereby possible for the spray jet from the jet lance to always impinge on the surface of the workpiece at approximately identical angles.

It has furthermore been found to be advantageous for the liquid used for the removal to be a cooling lubricant, preferably a water-miscible cooling lubricant. The concentrate in this mixture is selected in such a way that an emulsion containing mineral oil or a synthetic solution free of mineral oil is available as the fluid. This cooling lubricant has the advantage that it cools the workpiece, and in particular the functional surface thereof (cylinder bore), which has previously been heated during the thermal coating. As a result, the workpiece can be machined more effectively and more quickly in the subsequent machining processes.

This cooling lubricant also has the advantage that it is not corrosive and therefore no corrosion appears on the workpieces treated by the method according to the invention.

Furthermore, such cooling lubricants are also used in the subsequent processes, such as for example honing or chamfering of the cylinder bore. As a result, this cooling lubricant is firstly already available, and there is no need to separate the liquids for removing the overspray from the cooling lubricants in the subsequent processes. This gives rise to a considerably simplified procedure. In addition, only one refurbishment and pump device is required for the entire production line.

It has been found to be sufficient if the cooling lubricant is fed to the nozzle or the nozzles, which form the liquid jet, at a pressure in a range of between 15 MPa and 60 MPa, preferably in a range of between 20 MPa and 50 MPa, and particularly preferably in a range of between 25 MPa and 40 MPa. These pressure ranges are much lower than the pressures indicated in the prior art for the conventional high-pressure water blasting. The lower operating pressures result in considerable advantages in terms of the energy requirement, but it is also possible for the design of the jet device according to the invention to be considerably simplified. In addition, the risk of an accident is lower on account of the lower operating pressures and, associated therewith, the lower kinetic energy of the liquid jet.

In order to further optimize the efficiency of the method according to the invention, and to keep the efficiency of the method according to the invention constantly high even in the case of very complex geometries, it is furthermore provided that the pressure at which the cooling lubricant is fed to the nozzles of the jet lance can be controlled depending on the rotatory and/or translatory position of the nozzles. Controlling the pressure is a possible way of subjecting sites at which the overspray adheres particularly stubbornly to a relatively high kinetic energy of the liquid jet in a targeted manner, in order to thereby achieve an optimum removal result. Conversely, the pressure can also be lowered if the overspray is very readily removable in a specific region.

In a similar way, it is also possible to control the volumetric flow rate of the cooling lubricant conveyed through the nozzles of the jet lance depending on the rotatory and/or translatory position of the nozzles.

The method according to the invention is part of a production chain and is of course employed only when one or more functional surfaces have been provided with a coating, for example by thermal spraying. Then, the method according to the invention can be used in direct succession in order to remove the overspray. In this case, the liquid jet also cools the workpiece, particularly if aqueous liquids are used. This is an additional positive effect of the method according to the invention, since, after thermal coating, the workpiece temperature may be above 100° C., and a subsequent honing operation, for reasons of dimensional stability, requires a workpiece temperature of at most 25° C. Then, the previously coated functional surface can be honed and, if appropriate, the edges of the honed functional surface can be provided with a chamfer.

Alternatively, it is also possible for firstly the coated functional surface to be actively or passively cooled, for example with a water-based coolant (cooling lubricant), and then honed. Following the honing, the overspray is removed by the method according to the invention, and finally the edges of the honed functional surface are provided with a chamfer.

The object on which the invention is based is also achieved by a jet lance for carrying out one of the preceding methods for completely or partially removing overspray, wherein the jet lance comprises a receptacle, at least one cooling lubricant connection and at least one nozzle, wherein the at least one nozzle of the jet lance includes a first angle α with a plane (Z-R plane) defined by the axis of rotation of the jet lance and a radius line, and wherein the first angle α is greater than 5° and smaller than 85°. In other words: a first angle α=0° corresponds to a radius line, whereas a first angle α=90° corresponds to a tangent.

In a corresponding manner, the at least one nozzle of the jet lance can include a second angle β with a plane (X-Y plane) arranged perpendicularly in relation to the axis of rotation (Z axis), wherein the second angle β is according to the invention >5° and <85°. Such a jet lance makes it possible to set the angle between the liquid jet and the surface of the workpiece in accordance with the method according to the invention.

If the contour of the workpiece is complex, it may also be advantageous if the at least one nozzle of the jet lance can be pivoted, such that the first angle α and/or the second angle β can be set. The pivoting device of the at least one nozzle can be actuated by a numerical controller, such that, during the machining, the liquid jet can always be oriented in such a way that it impinges on the workpiece surface as far as possible at a flat angle.

It is of course also possible and advantageous for a plurality of nozzles to be provided on a jet lance and for these nozzles to be oriented at various first angles a or second angles β. It is then possible, even when the workpiece has a complicated contour, to always direct the liquid jet onto each region of the workpiece at a favorable angle, even if the nozzles are arranged in a stationary manner, i.e. they cannot be pivoted, on the jet lance. Despite the simplified design of the jet lance, this leads to an optimum result.

In order to minimize the energy and cooling lubricant requirement of the jet lance according to the invention, it is furthermore provided that the nozzles can be switched on and switched off individually. These switching processes can also be effected during operation of the jet lance, such that this too makes it possible to achieve jet guidance which is optimized in terms of the energy and liquid requirement despite stationary nozzles.

In order to make it possible to simultaneously remove the overspray on the neighboring surfaces at both ends of a piston bearing surface of an internal combustion engine, it is provided in a further advantageous configuration that the nozzles are arranged at a distance from one another in the longitudinal direction of the Z axis of the jet lance, such that the overspray can be removed at the same time at both ends of the coated functional surfaces. This results in a reduction in the cycle times, which is a significant advantage particularly for the series production of internal combustion engines. It is also possible to completely dispense with masking. Automated application in large-scale production is therefore possible for the first time.

Further advantages and advantageous configurations of the invention are described in the drawing which follows, the description thereof and the patent claims thereof. All of the features disclosed in the drawing, the description thereof and the patent claims can be essential to the invention both individually and also in any desired combination with one another.

### DRAWING

FIG. 1 shows a coated piston bearing surface in longitudinal section, with a first exemplary embodiment of a jet lance according to the invention,

FIGS. 2 and 3 show details of the workpiece surface, examples of complex geometries and of complex contours of the workpiece in the immediate vicinity of the coated cylinder bore,

FIG. 4 shows a greatly enlarged schematic illustration of the removal process according to the invention,

FIG. 5 shows a particle of the overspray which has been removed by the method according to the invention, and

FIG. 6 shows an exemplary embodiment of a jet lance according to the invention, with which the overspray can be removed at the same time at both ends of the functional surface (piston bearing surface).

### DESCRIPTION OF THE EXEMPLARY EMBODIMENTS

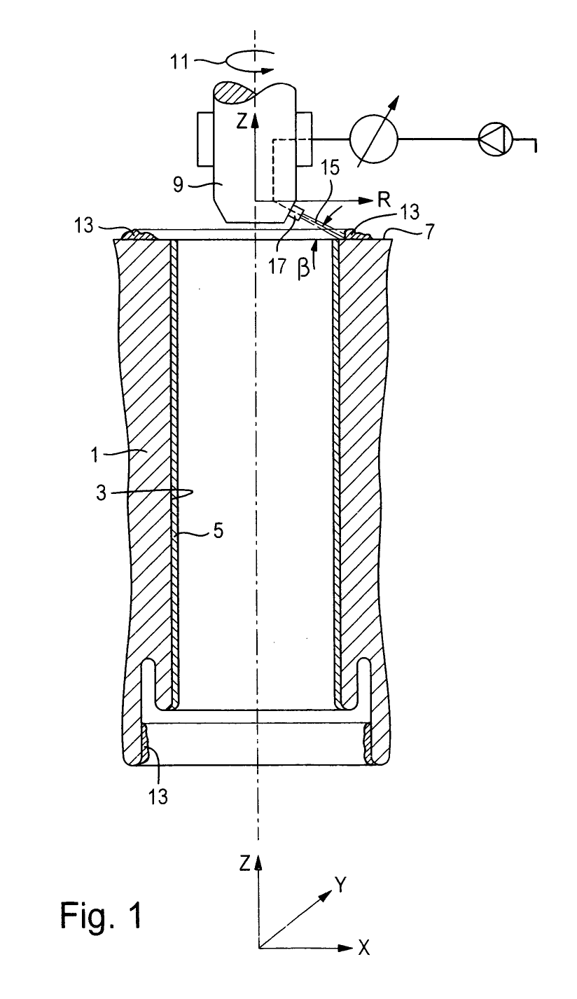

FIG. 1 shows a cylinder block 1, which is also referred to hereinbelow as the workpiece or substrate, with a piston bearing surface 3 in longitudinal section. A coating 5 has been applied to the piston bearing surface 3 by thermal spraying. After honing, this coating forms a functional surface which is optimized in terms of wear and oil consumption of the internal combustion engine.

In FIG. 1, the piston bearing surface 3 ends at the top at the so-called top surface 7, onto which the cylinder head gasket and the cylinder head are later placed (not shown).

At the bottom end of the piston bearing surface 3, the cylinder block 1 merges into the crankcase. In this case, it is important for the invention that the contour of the cylinder block 1 underneath the piston bearing surface 3 has protrusions, depressions and other “irregularities”.

At the bottom of FIG. 1, three coordinate axes X, Y and Z of a Cartesian fixed coordinate system are shown. Here, the Z axis is congruent with the longitudinal axis of the piston bearing surface 3 and an axis of rotation of a jet lance 9 according to the invention. The jet lance 9 rotates, as indicated by an arrow 11, about the Z axis.

An R axis, which runs in the direction of a radius line and is permanently connected to the jet lance 9, is therefore also plotted orthogonal to the Z axis on the jet lance. It therefore takes part in the rotational movement of the jet lance 9.

The piston bearing surface 3 is coated in that an appropriately formed lance (not shown) is inserted into the piston bearing surface in the direction of the Z axis, and in the process sprays the protective coating 5 onto the piston bearing surface 3. In this case, the lance moves in the direction of the Z axis and, at the same time, rotates about the Z axis. In the meantime, a jet of melted material, which forms the coating 5, is discharged radially from the lance, and is blown onto the piston bearing surface 3 with a high kinetic energy. In order to achieve optimum adhesion, the surface of the piston bearing surface 3 is prepared and degreased in accordance with this purpose. This results in a very close and nondetachable bond between the coating 5 and the actual piston bearing surface 3.

Since the jet with which the melted material is sprayed onto the piston bearing surface 3 by the lance (not shown) is widened somewhat before it impinges on the piston bearing surface 3, the jet ultimately has a conical form. This means that, whenever the lance draws closer to the top end or the bottom end of the piston bearing surface 3, a small, but not negligible, proportion of the melted material does not impinge on the piston bearing surface 3, but instead is deposited, for example, on the top surface 7 or in the bottom regions of the cylinder block 1 as so-called overspray. In FIG. 1, this overspray is denoted by the reference numeral 13.

Since the top surface 7 and the bottom regions of the cylinder block 1, unlike the piston bearing surface 3, are not prepared for coating with a sprayed-on coating, the adhesion of the overspray 13 is less effective than the adhesion of the coating 5 on the piston bearing surface 3.

The further distance which the jet covers from the jet lance until it impinges, for example, on the bottom regions of the cylinder block 1 also contributes to the relatively poor adhesion of the overspray 13 on the substrate 1. As a result, it is possible to determine that the adhesion of the overspray to the surface of the workpiece 1 is less effective than the adhesion of the coating 5 to the piston bearing surface 3.

The overspray 13 has to be removed from the workpiece 1, since otherwise it could become detached during operation of the internal combustion engine and pass into the oil circuit of the internal combustion engine. This may result in increased wear or capital consequential damage. In the region of the top surface 7, too, the overspray 13 has to be removed, since the cylinder head gasket can only be placed on when the top surface 7 is flat and no longer has raised areas in the form of overspray 13.

According to the invention, provision is therefore made to remove the overspray by one or more liquid jets 15, this liquid jet 15 being discharged from one or more nozzles 17 of the jet lance 9.

In the position of the jet lance 9 shown in FIG. 1, the overspray on the top surface 7 of the cylinder block 1 is removed. As is very clearly evident from this illustration, a second angle β between the liquid jet 15 and the top surface 7 is much smaller than 90°; it is approximately 30° to 40°.

A first angle α, which denotes the angle between a plane defined by the axis of rotation (Z axis) and a plane defined by the R axis, is not visible in the figures and is therefore not shown.

According to the invention, it is provided that the liquid jet 15 does not impinge on the overspray 13 perpendicularly, but rather impinges on the workpiece surface as far as possible at a small angle, i.e. a flat angle. This has the effect that the liquid jet 15 penetrates to a certain extent like a wedge between the overspray 13 and the top surface 7, and the overspray is thereby peeled off from the top surface 7. As a result, the rate at which the overspray 13 is removed is increased considerably, and a relatively low operating pressure of, for example, 28 MPa suffices for ensuring reliable and quick removal of the overspray.

The angle at which the liquid jet 15 impinges on the surface of the workpiece 1 is determined by the first angle α and the second angle β.

The jet lance 9 has to be positioned to such an extent above the top surface 7 that the jet 15 no longer passes into the bore 3, but rather exclusively impinges on the top surface.

In tests, it has been found that angles α and/or β of >5° are sufficient for achieving the desired peeling action or splitting action of the liquid jet 15. Conventional removal methods which are carried out with a high-pressure water jet direct the water jet diffusely onto the coating to be removed, here the overspray 13, and shatter the overspray 13 with the aid of a very high water pressure. This procedure is much more energy-intensive, and demands higher structural expenditure owing to the higher operating pressure. By contrast, the method according to the invention also has the further advantage that the removal rate is increased considerably.

It goes without saying that the discharge direction of the nozzle 17 has to be selected and oriented in accordance with the workpiece surface to be machined, here the top surface 7, such that the small angle according to the invention between the surface to be machined and the spraying agent jet 15 is ensured.

If, for example, the same spray lance 9 is dipped into the piston bearing surface 3 to such an extent that the spraying agent jet 15 impinges on the overspray 13 at the bottom end of the cylinder block 1, this spraying agent jet would impinge on the overspray at an angle of approximately 60°. As a result, the peeling action of the method according to the invention would be reduced, and in this respect the method according to the invention would not achieve its optimum performance.

FIG. 1 shows only one nozzle 17 and one spraying agent jet 15. It is of course also possible to provide a plurality of nozzles 17 (not shown in FIG. 1) which are distributed over the circumference and, even though they are offset over the circumference, are directed at the top surface 7 at the same angle β. Such a group of aligned nozzles 17 is referred to hereinbelow as a nozzle register.

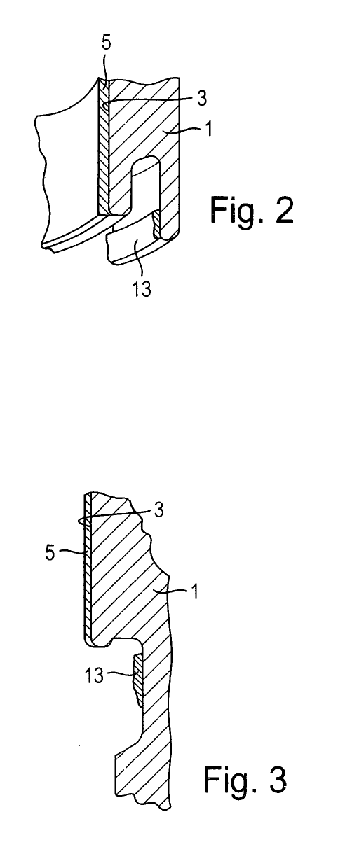

If, within the context of the method according to the invention, the intention is to peel off or remove the overspray 13 at the bottom end of the cylinder block, the nozzles 17 have to be oriented differently. This becomes clear from FIGS. 2 and 3, which show in each case different configurations of the bottom end of a piston bearing surface 3 and of the adjacent regions with overspray 13. FIGS. 2 and 3 are intended to show that a wide variety of geometries and contours of surfaces of the workpiece 1 adjacent to the end of the cylinder bearing surface 3 are possible, and as a consequence the nature, size and shape of the overspray can also be accordingly different.

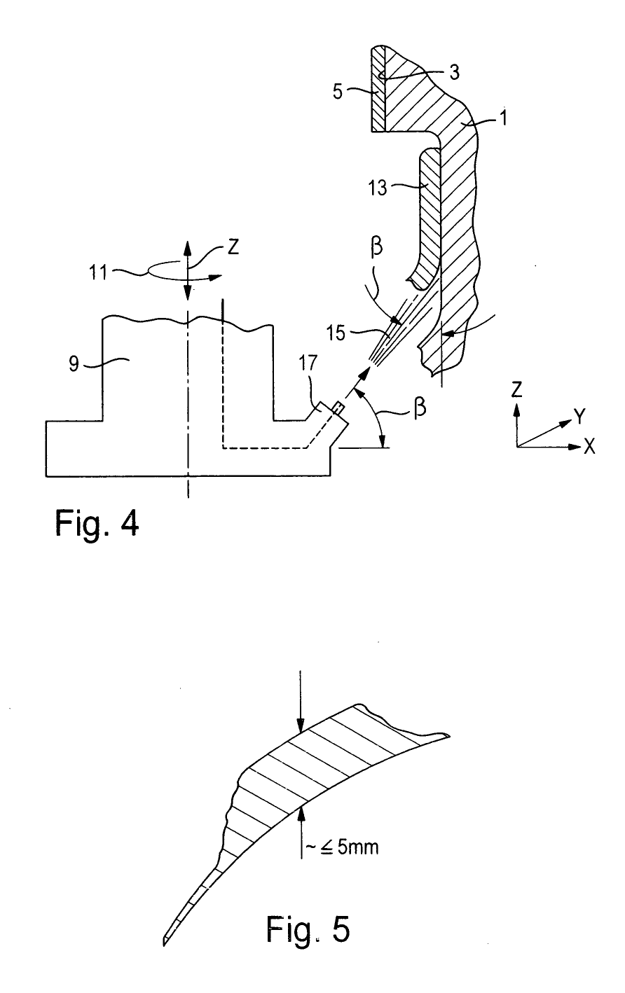

In order to make it possible to remove, for example, the overspray 13 shown in FIG. 3 as well as possible according to the method according to the invention, FIG. 4 shows a second exemplary embodiment of a spray lance 9. In this exemplary embodiment of a spraying agent lance 9, the nozzle 17 is directed upward, to be precise in such a way that the spraying agent jet 15 impinges at a second angle β of approximately 45° on the surface of the workpiece in the region in which overspray is present on the workpiece 1. In this case, the second angle β between the jet 5 and the workpiece surface is greater than in the exemplary embodiment shown in FIG. 1, owing to the contour of the workpiece 1.

In the exemplary embodiment shown in FIG. 4, the overspray 13 is present in a recess in the workpiece 1, such that the jet 15 only reaches all of the regions of the workpiece 1 which are covered by the overspray 13 when it is directed at a somewhat steeper angle onto the workpiece surface. Since, however, the site at which the jet 15 begins to remove the overspray 13 is at the furthest distance from the piston bearing surface 3, here the thickness of the overspray 13 is minimal and the adhesion of the overspray 13 is at its worst. Therefore, even with this slightly larger angle between the jet 15 and the workpiece surface, it is readily possible according to the invention to peel off the overspray. In this case, relatively large pieces of overspray 13 flake off from the surface of the workpiece 1, such that overall a very efficient and effective removal of the overspray 13 is established despite the angle of approximately 45° between the jet 15 and the workpiece surface.

FIG. 5 shows, by way of example and in greatly enlarged form, such a particle of overspray 13 which has flaked off. The evaluation of tests which have been carried out in practice has shown that particles having a length of approximately 10 mm and a width of approximately 5 mm flake off, and therefore the overspray 13 is not shattered but instead is peeled off, as is also shown by FIGS. 1 and 4. The mechanism of action according to the invention is based on the fact that the jet 15 penetrates between the overspray 13 and the substrate or the workpiece surface 1 in the manner of a “splitting wedge”.

It would of course also be possible to integrate a plurality of registers of nozzles 17 in a lance 9, these issuing in each case at different angles from the lance 9. These various registers could then be activated either at the same time or in succession, depending on the course of the surface of the workpiece. As a result, it is always possible to achieve an optimum angle between the jet 15 and the workpiece surface, even if the nozzles 17 are incorporated rigidly, rather than pivotably, in the lance 9.

If the various nozzle registers can be activated individually, it is also possible at the same time for the demand for spraying agent and the demand for drive power to be minimized.

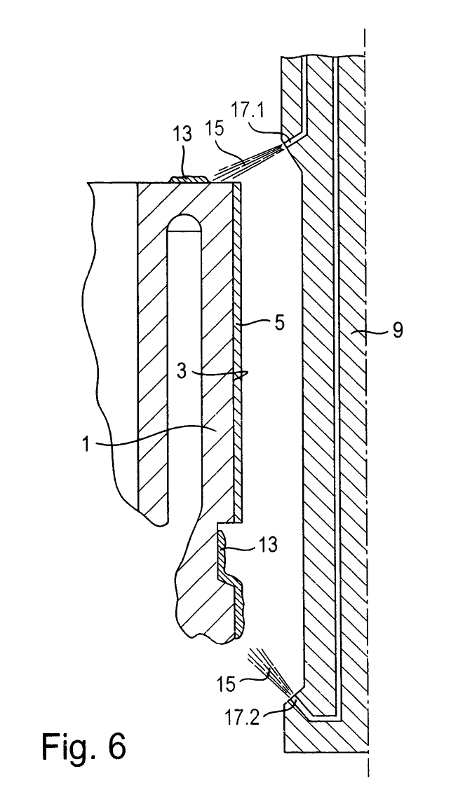

FIG. 6 shows such an exemplary embodiment of such a lance 9. This lance 9 projects through the entire piston bearing surface 3. The first register of nozzles 17.1 is directed at the overspray on the top surface 7, whereas a second register of nozzles 17.2 is directed from below at the overspray in the region underneath the piston bearing surface 3. This lance 9 is to some extent the combination of the lances shown in FIGS. 1 and 4. As a result, it is possible to remove the overspray 13 above and underneath the piston bearing surface 3 at the same time and with a high degree of efficiency, which reduces the cycle times and makes the method according to the invention even more economical.

It is also possible to mount the nozzles 17 pivotably in the lance 9, such that they can be directed at the surface of the workpiece 1 according to the current position of the lance 9, and therefore the jet impinges on the surface of the workpiece 1 at the smallest possible angle. This achieves the best possible peeling action or splitting action between the overspray 13 and the workpiece, and therefore the overspray 13 can be removed quickly and reliably with a low expenditure of spray and energy.

The use of the cooling lubricant present in the machine for the machining renders the hydromechanical removal of overspray 13 even more economical. There is no need for a separate circuit or a washing machine between the processes, but instead it is possible to use one and the same fluid both for machining and for the removal of the overspray 13.

Local pressure adaptation to the course of the topography is possible by virtue of an automated cycle. This is required when the course of the workpiece surface to be blasted is unfavorable.

Jet parameters in the exemplary embodiment:

Pressure: 28 MPa

Volumetric flow rate/nozzle: 5.6 l/min

Number of nozzles: 6

Nozzle diameter: 0.9 mm

Overall volumetric flow rate: 34 l/min

Nozzle spacing: ≧15 mm

Material of the nozzles: Sapphire

1-22. (canceled)

23. A method for removing overspray of a coating which has been sprayed onto a workpiece, the method comprising the step of:
directing at least one liquid jet from a jet lance as a hydrodynamic wedge in a parting plane between the workpiece and the overspray onto regions of the workpiece having overspray.

24. The method of claim 23, wherein at least one liquid jet is directed onto a region of a surface of the workpiece having overspray at an angle of smaller than 90°, smaller than 30° or smaller than 10° and greater than 5°.

25. The method of claim 23, wherein the liquid jet is guided from non-coated regions of the workpiece to the regions having overspray.

26. The method of claim 23, wherein the jet lance and/or a discharge direction of the at least one liquid jet is controlled depending on an orientation of a surface of the workpiece in regions having overspray.

27. The method of claim 23, wherein the jet lance performs a rotational movement.

28. The method of claim 23, wherein the jet lance is arranged coaxially in relation to a cylinder bore.

29. The method of claim 23, wherein a direction of at least one liquid jet subtends a first angle with a Z-R plane defined by an axis of rotation (Z) of the jet lance and a radius line (R), wherein the first angle is greater than 5° and smaller than 85°.

30. The method of claim 23, wherein a direction of at least one liquid jet subtends a second angle with an X-Y plane disposed perpendicular to an axis of rotation (Z), wherein the second angle is greater than 5° and smaller than 85°.

31. The method of claim 23, wherein at least one nozzle of the jet lance can be pivoted in a Z-R plane defined by an axis of rotation (Z) of the jet lance and a radius line (R) and/or in an X-Y plane disposed perpendicular to the axis of rotation (Z).

32. The method of claim 23, wherein a liquid used is a cooling lubricant, preferably a water-miscible cooling lubricant and/or a synthetic cooling lubricant.

33. The method of claim 23, wherein the cooling lubricant is fed to nozzles, which form the liquid jet, at a pressure in a range of between 15 MPa and 60 MPa, between 20 MPa and 50 MPa or between 25 MPa and 40 MPa.

34. The method of claim 23, wherein a pressure at which the cooling lubricant is fed to nozzles of the jet lance is controlled depending on a rotatory and/or translatory position of the nozzles.

35. The method of claim 23, wherein a volumetric flow rate of cooling lubricant conveyed through nozzles of the jet lance is controlled depending on a rotatory and/or translatory position of the nozzles.

36. The method of claim 23, further comprising the steps of honing, subsequent to removal of the overspray, a coated functional surface and providing, following honing, edges of a honed functional surface with a chamfer.

37. The method of claim 23, wherein a coated functional surface is cooled by at least one liquid jet during removal of the overspray.

38. The method of claim 23, wherein a coated functional surface is first actively or passively cooled and honed, the overspray is subsequently removed and edges of a honed functional surface are then provided with a chamfer.

39. A jet lance for carrying out the method of claim 23, the jet lance comprising:
at least one cooling lubricant connection; and
at least one nozzle, said at least one nozzle subtending a first angle with a Z-R plane defined by an axis of rotation (Z) of the jet lance and a radius line (R), wherein said first angle is greater than 5° and smaller than 85°.

40. A jet lance for carrying out the method of claim 39, wherein said at least one nozzle subtends a second angle with an X-Y plane disposed perpendicular to an axis of rotation (Z) of the jet lance, wherein said second angle is greater than 5° and smaller than 85°.

41. The jet lance of claim 40, wherein said at least one nozzle of the jet lance can be pivoted for setting said first angle and/or said second angle.

42. The jet lance of claim 40, wherein a plurality of nozzles are provided and said nozzles are oriented at various first angles and/or second angles.

43. The jet lance of claim 40, wherein nozzles can be switched on and switched off individually.

44. The jet lance of claim 40, wherein nozzles are arranged at a distance from one another in a direction of a Z axis, such that the overspray can be simultaneously removed at both ends of a coated functional surface.
